(19) United States
(12) Patent Application Publication
(10) Pub. No.: US 2010/0129279 A1
(43) Pub. Date: May 27, 2010

(54) Extraction and Purification of Minerals From Aluminium Ores

(75) Inventor: Robert Lloyd, New South Wales (AU)

Correspondence Address: NIXON & VANDERHYE, PC, 901 NORTH GLEBE ROAD, 11TH FLOOR, ARLINGTON, VA, 22203, US

(73) Assignee: KARALEE RESEARCH PTY LIMITED, Berkeley Vale, New South Wales (AU)

(21) Appl. No.: 12/086,537

(22) PCT Filed: Dec. 14, 2006
(86) PCT No.: PCT/AU2006/001904

§ 371 Date: Sep. 11, 2008

(30) Foreign Application Priority Data
Dec. 14, 2005 (AU) 2005907032

(51) Int. Cl. C22B 21/00; C22B 34/12; C01F 7/50; C01G 23/02

(52) U.S. Cl. 423/85; 423/122

(57) ABSTRACT

A process for obtaining one or more metal fluoride or metal oxide compounds from treatment of a feed material containing aluminium ore, includes the steps of contacting the feed material with a fluorine acid solution to form gaseous silicon fluoride and aqueous soluble metal fluorides and/or metal fluosilicates, processing the aqueous reaction products to form a solid reaction product containing metal fluorides, processing to remove low boiling point compounds and heating said solid reaction product to a temperature to drive off metal fluoride in gaseous form. The feed material may include aluminium ores and/or titanium ores, coal or other carbonaceous materials containing mineral impurities, or other minerals such as mica. Processes for the production of aluminium and titanium compounds are also described.

### BACKGROUND OF THE INVENTION

1. Field of the Invention

The present invention relates to the extraction and purification of minerals from aluminium ores, including clays, clay minerals, leached clays, leached clay minerals, bauxite, carbonaceous materials, such as coal, which contain mineral impurities of a similar type, and other minerals such as mica.

2. Description of Related Art

U.S. Pat. No. 4,780,112 describes a process for the treatment of carbonaceous materials—i.e. those composed predominantly of elemental carbon, such as coal, lignite and graphite—to remove non-carbonaceous impurities such as clay and in particular silica, alumina and other minerals by treatment with an aqueous solution of hydrofluorosilicic acid H₂SiF₆ (also called fluosilicic acid) and hydrofluoric acid HF.

WO 03/074639 describes a process for the treatment of carbonaceous materials—i.e. those composed predominantly of elemental carbon, such as coal, lignite and graphite—to remove sulfur and other non-carbonaceous impurities such as sulfur, silica, alumina and other minerals. In that process, the carbonaceous material is first contacted with a fluorine acid solution containing hydrofluoric acid HF and/or hydrofluorosilicic acid H₂SiF₆, and reaction products are then separated from the carbonaceous material. The reaction products may include gaseous silicon tetrafluoride SiF₄, and a mixed metal fluoride and fluosilicate solution which may be crystallized and pyrohydrolysed for conversion to the more stable metal oxides for disposal and to recycle the fluorine within the process.

WO 2004/057043 describes a process for purification of inorganic minerals, specifically iron or titanium oxides, or mixtures thereof in which a mineral mixture is reacted with a fluorine acid solution to separate minerals which react with the solution from those which do not.

The contents of U.S. Pat. No. 4,780,112, WO 03/074639 and of WO 2004/057043 are incorporated herein by reference.

Much of the world's alumina is produced by processing of bauxite-defined by the US Geological Survey (USGS) as a rock or ore with a minimum of 24 wt % alumina. As one example, it is a naturally occurring alumina-silica based clay in which the alumina to silica ratio has been increased by leaching of the silica content over the millennia. Bauxite contains three aluminium minerals—Gibbsite, Boehmite and Diaspore—in differing proportions depending on the deposit. The total percentage of the aluminium mineral, measured as alumina, by ash analysis, in the bauxite may vary from about 24 wt % to about 70 wt %, and the reactive silica content, measured as silica, may vary from about 1 wt % in a highly leached deposit to about 20 wt % for a less highly leached deposit.

The dominant method for production of alumina is the Bayer method. This method comprises treating the bauxite with sodium hydroxide in a digester to dissolve the aluminium minerals, followed by settling, precipitation and calcining of the aluminium trihydroxide (“hydrate”) to alumina.

The Bayer process has substantial disadvantages. Firstly, the non-alumina components of the bauxite, which make up in the order of 30 to 76 wt % or more of the ore, are rejected from the process as a highly alkaline “red mud” which is extremely environmentally undesirable. Managing this red mud adds very substantially to the operating cost of the process. Furthermore, the Bayer process is generally economically unsuitable for bauxite deposits having a reactive silica content greater than 7 wt % due to the need to form insoluble sodium aluminium silicates, to extract the silica contaminant from the process before the crystallization of the aluminium hydroxide compound. The loss of sodium aluminium silicates represents a loss of aluminium value yield from the bauxite and a loss of process reagent.

Nevertheless, the Bayer process has remained the dominant method of alumina production for over a century due to lack of a suitable alternative.

Surprisingly, the present inventor has found that, by adaption of the processes of U.S. Pat. No. 4,780,112 and WO 03/074639, substantial quantities of relatively pure aluminium values and/or pure other compounds may be derived from the mineral impurities in the carbonaceous material, which contain a high proportion of alumina-silica clay minerals.

The inventor has found also that the process may be used to treat other clays, leached clays such as bauxite, and aluminium ores to result in relatively pure aluminium values and/or relatively pure other compounds.

### SUMMARY OF THE INVENTION

In a first form, the invention provides a process for obtaining one or more metal fluoride compounds from treatment of a feed material containing an aluminium ore, including the steps of:

contacting said feed material with a fluorine acid solution to react said fluorine acid solution with reactive mineral species within the aluminium ore to form gaseous silicon fluoride and aqueous soluble metal fluorides and/or metal fluosilicates as reaction products;
separating the gaseous silicon fluoride from the reaction products and unreacted species of the feed material;
separating the aqueous soluble reaction products from unreacted species of the feed material;
processing the aqueous soluble reaction products to form a solid reaction product containing metal fluorides and optionally metal fluosilicates and/or hydrates of said metal fluorides and metal fluosilicates;
converting any metal fluosilicates in said solid reaction product to metal fluoride and removing any low boiling point compounds from said solid reaction product; and
heating said solid reaction product to a temperature to drive off said metal fluoride in gaseous form.

Preferably, said aluminium ore comprises aluminosilicate minerals, such as clays or leached clays.

Preferably, said reactive mineral species include at least titanium and aluminium minerals.

Preferably, said metal fluoride is aluminium trifluoride.

Preferably, the predominant (highest percentage) mineral of the total mineral content of the feed material is aluminium or silicon, as measured by ash analysis.

It is preferred that the aluminium ore or clay or leached clay component of the feed material is a high alumina ore or clay having at least 12 wt % alumina, preferably from 12 wt % to 70 wt % and more preferably from 24 wt % to 55 wt %, as measured by ash analysis. The silica component of the ore or clay or leached clay in the feed may vary from 1 wt % for leached clays to 82 wt % for unleached ores.

In one form, the invention further comprises the step of converting the gaseous aluminium trifluoride produced to aluminium oxide.

Preferably, the step of removing low boiling point compounds—those having boiling or sublimation points below the boiling or sublimation point of the particular metal fluoride which it is desired to extract—includes heating the reaction products to a temperature below the sublimation point of desired metal fluoride. In preferred form, the removal step includes heating the reaction products to a temperature at which one or more of said low boiling point compounds are removed and separated in relatively pure form.

Preferably, the step of removing low boiling point compounds includes heating to remove titanium tetrafluoride in gaseous form and optionally its formation as a purified solid or as titanium oxide.

Other preferred methods of removing low boiling point compounds include solvent extraction, pressure, gravity separation and/or preferential chemical reaction of the low boiling point compounds.

In another preferred form, said metal fluoride is titanium tetrafluoride.

In one embodiment of the invention, the feed material is a carbonaceous material containing the alumina clay as an impurity. Preferred forms of carbonaceous material include coal including brown coal, coke, lignite, anthracite, charcoal, graphite and the like.

Preferably, the carbonaceous material is a coal containing from 1-50 wt % ash content, for example from 4-30 wt % ash content.

In another embodiment, the feed material is the aluminium ore, or alumina clay, for example, a leached alumina clay such as laterite origin bauxite.

A further form of the invention provides a process for obtaining one or more aluminium compounds from treatment of a bauxite feed material, including the steps of:

contacting said feed material with a fluorine acid solution to react with aluminium values and other reactive mineral species within the feed material to form gaseous silicon fluoride and aqueous soluble metal fluorides and/or metal fluosilicates;
separating the gaseous silicon fluoride from the reaction products and unreacted species of the feed material;
separating the reaction products from unreacted species of the feed material; processing the reaction products to form a solid reaction product containing aluminium trifluoride and/or its hydrates; and
separating the aluminium trifluoride and/or hydrates from the reaction product.

Preferably, the step of separating the aluminium trifluoride includes the steps of:

removing low boiling point compounds from said solid reaction product; and
heating said solid reaction product to a temperature to drive off gaseous aluminium trifluoride.

A yet further form of the invention provides a process for obtaining one or more titanium compounds from treatment of a feed material containing an aluminium and titanium ore, including the steps of:

contacting said feed material with a fluorine acid solution to react said fluorine acid solution with aluminium and titanium values and other reactive mineral species within the aluminium ore to form gaseous silicon fluoride and aqueous soluble metal fluorides and/or metal fluosilicates as reaction products;
separating the gaseous silicon fluoride from the aqueous reaction products and unreacted species of the feed material;
separating the aqueous reaction products from unreacted species of the feed material;
processing the aqueous reaction products to form a solid reaction product containing titanium and aluminium metal fluorides, optionally titanium and aluminium metal fluosilicates and/or hydrates of said titanium and aluminium fluorides and metal fluosilicates; and
heating said solid reaction product to a temperature to drive off said titanium metal fluoride in gaseous form.

Preferably, the major mineral components of said aluminium and titanium ore are aluminium and/or silicon minerals.

Further forms of the invention include apparatus for carrying out the processes, and compounds such as aluminium, titanium and silicon compounds when made by the processes.

Other forms of the invention are as set out in the claims.

### BRIEF DESCRIPTION OF THE DRAWINGS

Further preferred embodiments of the invention will now be described with reference to the accompanying drawings, in which:

FIG. 1 is a flowchart illustrating a method for purification of carbonaceous material according to the prior art WO 03/074639;

FIG. 2 is a flowchart of a circuit for processing of the aqueous reaction products from the process of FIG. 1 for the production of alumina, according to a first embodiment of the invention; and

FIG. 3 is a flowchart illustrating a method for producing alumina from treatment of bauxite, according to a second embodiment of the invention.

### DETAILED DESCRIPTION OF PREFERRED EMBODIMENTS

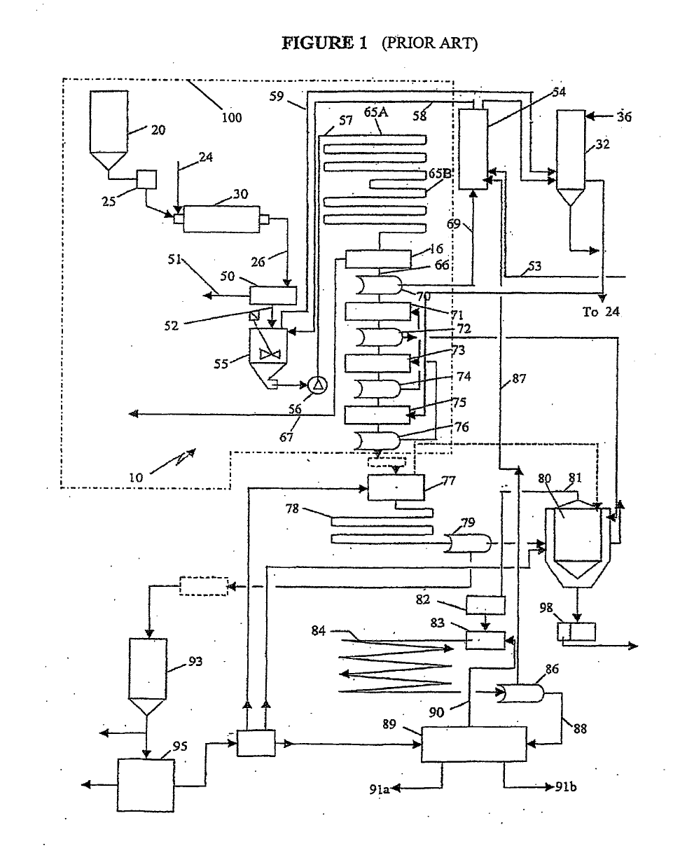

FIG. 1 shows a process for treating an impure carbonaceous material according to WO 03/074639.

This process is described in relation to carbonaceous material, and is applicable to such materials as coal and graphite and the like.

The details of the process are fully described in WO 03/074639, which is incorporated herein by reference. Those process steps that deal with the liberation of mineral matter, particularly clay, from carbonaceous material, are reproduced in summary form. The additional steps of purifying these liberated minerals, to in large provide them in a useful and environmentally friendly form, are detailed.

The mineral material to be separated and purified is normally of a size 2 mm minus, but not exclusively so, as large particles can be effectively treated with appropriate adjustment of process parameters such as reactor size and residence times. Such material is fed via a hopper 20 and feed unit 25 into a series of reactors, for example a flowthrough, stirred or rotating purification reactor 30, stirred reactor 55 and two-stage tubular reactor 65A,65B, as described in WO 03/074639. The combination of reactors to be used is dependent on the material itself and its properties, such as density.

The fluorine acid solution treatment of the mineral matter in these reactors, particularly clay, may be by hydrogen fluoride, hydrofluorosilicic acid, or preferably by a ternary mixture of hydrogen fluoride and hydrofluorosilicic acids. The mixing of hydrogen fluoride and hydrofluorosilicic acid may be achieved external to the reactors, for example in an absorption vessel such as 54, or may be achieved internally in the reactors as a product of reaction of the HF with SiO₂.

Preferably, the fluorine acid solution is saturated with respect to hydrofluorosilicic acid (approx 32 wt %, but dependent on temperature), with the HF concentration varied to achieve the desired acidity or pH value.

By the fluorine acid solution being saturated with respect to hydrofluorosilicic acid, the SiF₄ given off by the reaction will be in gaseous form. The acid feed to the reactor may be at the desired hydrofluorosilicic acid saturation, or the feed may be less than saturated and the hydrofluorosilicic acid saturation achieved by the reaction of the HF with SiO₂ as discussed above.

The reactions are preferably carried out at a temperature of approximately 30-80° C., more preferably about 65-80° C., and most preferably about 70° C.

At the end of the reactor series, separator 16 separates the output stream into a solids stream 67, which includes heavy unreacted solids such as the passivated iron compounds, and a mixed liquid/coal stream 66 which may then undergo further physical separation for example at belt filter 70 and alternating mixing tanks 71,73,75 and separators, such as centrifuges or belt filters 72, 74, 76. The coal, from which most of the mineral material has been removed, is further processed as described for example in WO 03/074639, while the aqueous stream is further processed as described below.

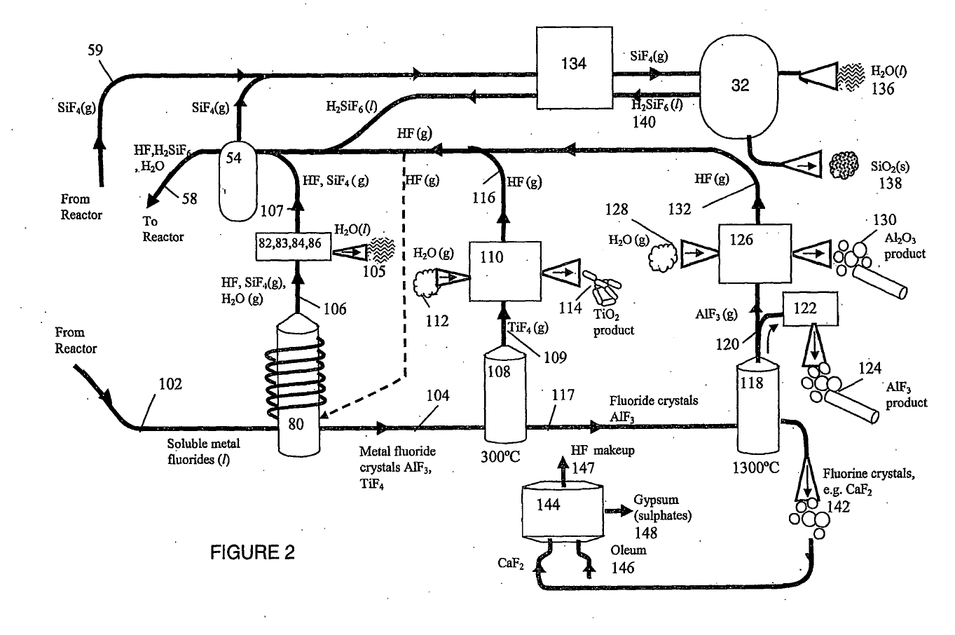

FIG. 2 is a flowchart illustrating the processing of the aqueous portion separated out of the mixed coal/aqueous stream in line 66 from separator 16, in a case where the original carbonaceous material feed contains a substantial amount of aluminium ore or alumina-silica based clay, or leached clay, as an impurity, such as the mineral bands predominantly found in coal seams.

The process of FIG. 2 links to that part of the FIG. 1 process flowchart contained within broken line 100, with similar reference numerals being used for analogous items.

Typically, coal will contain from about 1-50 wt %, more usually about 4-30 wt %, total mineral (ash) content, which largely comprises aluminium ore or clay material and other mineral inclusions such as pyrite FeS₂ and quartz SiO₂. Of that mineral content, typically about 15-35 wt % is aluminium and about 50-80 wt % is silicon (on ash analysis), with significant titanium and iron contents.

Clays are phyllosilicate minerals which contain large percentages of water between the silicate sheets, giving them characteristic physical properties. The main families of clay minerals found in coal are the Kaolinite, Chlorite, Montmorillonite/Smectite and Mite groups. Clays are usually formed by in situ weathering of rock or by secondary sedimentary processes, but may also be formed in primary igneous or metamorphic environments.

The major clay minerals present in coal will typically be kaolinite Al₂Si₂O₅(OH)₄, chlorite (MgFeAl)₆(SiAl)₄O₁₀(OH)₈, illite—which is similar to muscovite KAl₂(Si₃Al)O₁₀(OH)₂ but with less K⁺, more SiO₂ and H₂O and containing small amounts of Mg and Fe—and mixed-layered clays, which are usually randomly interstratified mixtures of illite with montmorillonite and/or chlorite. Other metal cations may also be present in small proportions within the clay lattice.

The aqueous stream 102 contains soluble mixed metal fluorides and/or fluosilicates formed by the reaction of the fluorine acid feed 24 (FIG. 1) and/or 58 with certain of the impurities in the carbonaceous material feed 25 in the purification reactors 30,55,65A, 65B, or a combination thereof. Examples of metal fluorides and/or metal fluosilicates in this stream are compounds of Al, Ti, Ca, Mg, but not exclusively so. As an example of the purification of one of the original minerals in clay, or the mineral impurity in carbonaceous substrates of the other main components of the impurities, the passivated iron values typically, but not exclusively so, continue through unreacted with the stream of carbonaceous material into a separator 16 (FIG. 1), where they are discharged as stream 67 (FIG. 1), which can be of high purity values of iron oxide or other iron compounds. As another example, the silica impurity in the original material is given off as gaseous SiF₄ through vent line 59 and further purified as discussed later.

The mixed metal fluoride and/or metal fluosilicate solution from filter 70 and/or separator 72 of FIG. 1 is ultimately passed to a crystallizer 80, or is partially diverted to the absorber 54 of FIG. 1 and to the crystallizer 80. The solution passing to the crystallizer is concentrated by heating to precipitate mixed metal fluoride and metal fluosilicate crystals. Water, HF and SiF₄ are given off in gaseous form 106, passing to a dewatering stage 82,83,84,86, such as contact with anhydrous AlF₃, calcium fluosilicate CaSiF₆ or other material capable of removing water without reacting with the HF and SiF₄, as described more fully in WO 2004/057043.

The gaseous HF and SiF₄ 107 is returned to the ternary acid absorber 54, which will be described in more detail later.

The mixed metal fluoride and metal fluosilicate crystals, which in the example of FIG. 2 comprise mainly AlF₃ and TiF₄ are passed to a series of sublimation/boiling chambers, separators or reactors.

As an example of the purification of one of the original minerals in the clay, or the mineral impurity in carbonaceous substrates, in one of these chambers, which itself may be multichambered, the mixed crystals are gradually heated to remove the water of hydration of the AlF₃ and other crystals. Heating continues as the crystals move through the chamber/chambers to finally cause the sublimation of the TiF₄ crystals at approximately 300° C. at atmospheric pressure in sublimation chamber 108, and the high purity gaseous TiF₄ 109 formed may be passed to a pyrohydrolysis reactor 110, where TiF₄ gas is contacted with steam 112 to form high purity TiO₂ solid 114 and gaseous HF 116. The TiO₂ formed is of high purity and suitable for collection and sale, while the HF is returned to the ternary acid absorber 54 or the crystallizer 80.

In an unillustrated alternative embodiment, the high purity TiF₄ gas 109 may be cooled to form a high purity solid, in a manner similar to that described below for the AlF₃, or reacted to form another purified titanium compound.

If required, the remaining metal fluoride crystals 117 are then passed to further separators, and/or reactors and/or sublimation/boiling chambers (not shown). For example, with sublimation/boiling chambers, operation at progressively higher temperatures to remove any other compounds with a boiling or sublimation point below the sublimation point of that of the metal fluoride which it is desired to extract, which in this example is aluminium trifluoride (sublimation point approximately 1260-1300° C. at 1 atmosphere).

Alternatively, or in addition, other processes such as preferential reaction or solvent extraction or density separation or pressure changes may be used to remove other compounds having boiling/sublimation points below that of the aluminium trifluoride.

Preferably, the operations downstream of the crystallizer to at least the AlF₃ sublimation chamber are conducted at low pressure—less than 4 atmospheres, preferably less than 2 atmospheres, and most preferably less than or at 1 atmosphere.

The residual crystal mixture of AlF₃ and higher boiling point compounds then passes to an AlF₃ sublimation chamber 118 at approximately 1260-1300° C. (at atmospheric pressure).

The sublimation chamber is preferably lined with pure pyritic graphite, preferably having been purified by the process of WO 03/074639 or WO 84/04759, and is under inert atmosphere, to prevent unwanted reactions from occurring which may cause contamination of the gaseous AlF₃. However, high alumina refractory systems may also be used, or other compatible refractory systems.

In another example of the separation and purification of one of the original minerals in the clay, or the mineral impurity in carbonaceous substrates, the gaseous AlF₃ 120 discharged from the aluminium trifluoride sublimation chamber 118 may be collected and cooled 122 for discharge as solid high purity AlF₃ 124 or, optionally, may be further processed by pyrohydrolysis in a pyrohydrolysis reactor 126 with steam 128 to form high purity alumina 130, Al₂O₃, or both. Both the high purity AlF₃ and Al₂O₃ can be collected for sale. Again, gaseous HF 132 from the pyrohydrolysis reaction is returned to the ternary acid absorber 54, or crystallizer 80.

In the ternary acid absorber 54, the returned HF and SiF₄ is contacted with an aqueous fluorine acid solution to replenish the HF and H₂SiF₆ concentrations for return to the reactor system. Any SiF₄ beyond that required to result in a solution of saturation with respect to H₂SiF₆ at the relevant temperature, e.g. beyond approximately 32 wt % H₂SiF₆ for example at one temperature, will pass through unabsorbed and is merged with the gaseous SiF₄ stream from the reactor system for further processing.

The ternary acid solution of HF, H₂SiF₆ and H₂O is returned to reactor system.

Further details of the ternary acid absorber are described in WO 2004/057043.

In another example of the separation and purification of one of the original minerals in the clay, or the mineral impurity in carbonaceous substrates, gaseous SiF₄ from each part of the process passes through a cleaning bath/baths 134, comprising saturated H₂SiF₆ acid, which is concentrated and purified within the process itself. This allows gaseous SiF₄ to pass without absorption and in a pure form, before being hydrolysed by contact with water feed 136 in a hydrolyser reactor 32 to form silica SiO₂ solids 138 and/or gel for collection and sale. The liquid stream 140 from the hydrolyser is the saturated aqueous stream of H₂SiF₆ used in the bath/baths and it is ultimately returned to the ternary acid absorber 54 and the reactor system.

In an unillustrated alternative embodiment, the gaseous SiF₄ may be collected in that form for transport and sale, or used for further processing. It will be appreciated that this may result in a net loss of fluorine from the process, and if so, will need to be replenished.

A small quantity of high boiling point material, primarily metal fluorides such as CaF₂ crystals 142, may remain in solid form following the aluminium trifluoride sublimation step. This stream may be passed to an HF recovery reactor 144 in which the CaF₂ crystals are contacted with oleum/sulfuric acid H₂SO₄ 146 for recovery of HF 147, and to form gypsum CaSO₄ 148 for sale or disposal, or it may be subjected to further purification steps, such as controlled high temperature, greater than 1300° C.

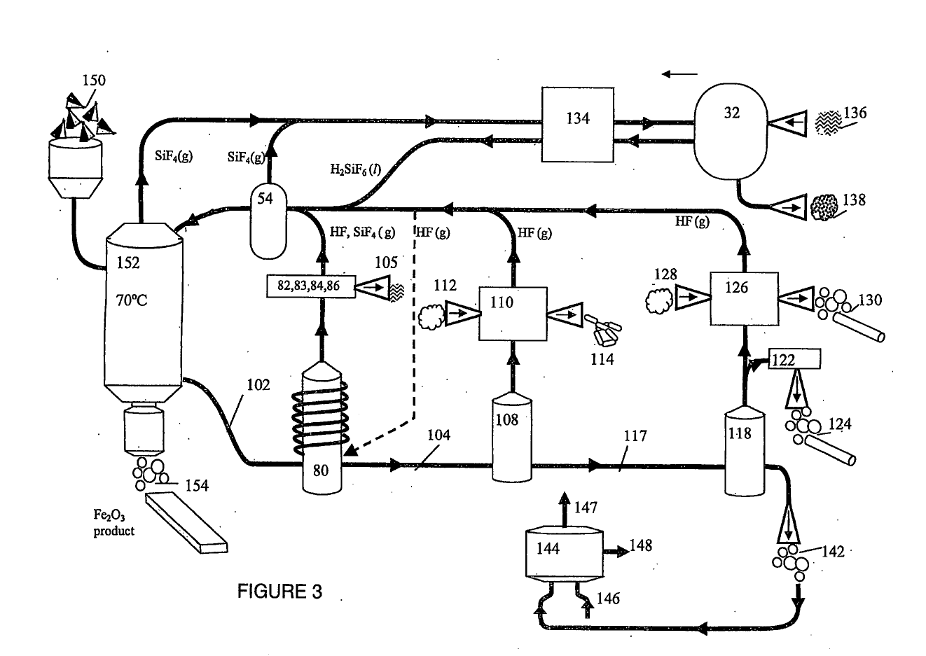

An additional CaF₂ makeup feed (not shown) may be provided to the HF recovery reactor 144 of FIGS. 2 and 3.

FIG. 3 is a flowchart of the treatment of bauxite according to a second embodiment of the invention.

In the example given in FIG. 3, but not exclusively so, the bauxite is sourced from the Weipa deposit (Australia) and has the following approximate composition:

| | |
|---|---|
| Al₂O₃ | 50-55 wt % |
| SiO₂ | 4-5 wt % |
| Fe₂O₃ | 12-17 wt % |
| Water/other | 25-26 wt % |

However, it will be appreciated that the invention is suitable for processing of a wide range of bauxite compositions, including those with lower alumina and higher silica and reactive silica percentages.

The bauxite 150 is fed in granular form, but may be of larger particle size, to the reactor series 152 where it is contacted with the ternary fluorine acid solution under the conditions described in WO 2004/057043, WO 03/074639 and U.S. Pat. No. 4,780,112.

In the embodiment of FIG. 3, a reactor temperature of approximately 70° C. is used.

The reaction of the bauxite with the fluorine acid solution causes formation of an aqueous metal fluorides and fluosilicates solution of the reactive species—primarily Al, Ti and Ca—which are separated from the solids stream and processed as described above with reference to FIG. 2.

The silica content of the bauxite reacts with the acid to form SiF₄, which again is processed as described for FIG. 2.

The unreacted solids discharge of the reactor is primarily iron oxide 154, which is suitable for further processing to recover the iron content, e.g. as feed for steel making, by processes which will in themselves be well understood in the art.

The present invention therefore allows recovery and purification of economically valuable components of the bauxite—typically aluminium, silicon, iron and titanium, and optionally calcium compounds, but not exclusively so,—for further processing, without the formation of the vast quantities of highly alkaline “red mud” waste formed by the Bayer process. Furthermore, by appropriate processing of the fluorine reaction products, much of the fluorine acid reagents used in the process are recovered for recycling, and the final products of the process are in their relatively inert oxide or sulfate forms, but not exclusively so.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises where they appear.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, the scope of the invention being indicated by the appended claims rather than the foregoing description, and all changes which come within the meaning and range of equivalency of the claims are therefore intended to be embraced therein. It will further be understood that any reference herein to known prior art does not, unless the contrary indication appears, constitute an admission that such prior art is commonly known by those skilled in the art to which the invention relates.

1. A process for obtaining one or more metal fluoride compounds from treatment of a feed material containing aluminium ore, including the steps of
contacting said feed material with a fluorine acid solution to react said fluorine acid solution with reactive mineral species within the aluminium ore to form gaseous silicon fluoride and aqueous soluble metal fluorides and/or metal fluosilicates as reaction products;
separating the gaseous silicon fluoride from the aqueous reaction products and unreacted species of the feed material;
separating the aqueous reaction products from unreacted species of the feed material;
processing the aqueous reaction products to form a solid reaction product containing metal fluorides, optionally metal fluosilicates and/or hydrates of said metal fluorides and metal fluosilicates;
converting any metal fluosilicates in said solid reaction products to metal fluorides and removing any low boiling point compounds from said solid reaction product; and
heating said solid reaction product to a temperature to drive off said metal fluoride in gaseous form.

2. A process according to claim 1, wherein said metal fluoride compound is titanium tetrafluoride or aluminium trifluoride.

3. A process according to claim 2, wherein said metal fluoride compound is aluminium trifluoride.

4. A process according to claim 1, wherein said feed material contains at least aluminium, silicon, iron and titanium minerals.

5. A process according to claim 1, wherein said aluminium ore comprises one or more aluminosilicate materials.

6. A process according to claim 5, wherein said one or more aluminosilicate materials comprise clays or leached clays.

7. A process according to claim 5, wherein said one or more aluminosilicate materials comprise leached clay.

8. A process according to claim 7, wherein said leached clay is bauxite.

9. A process according to claim 3, wherein said step of removing any low boiling point compounds comprises heating to remove titanium tetrafluoride in gaseous form.

10. A process according to claim 9, further comprising a step for converting gaseous titanium tetrafluoride to titanium tetrafluoride solid or to titanium dioxide.

11. A process according to claim 3, further comprising the step of converting the gaseous aluminium trifluoride produced to aluminium trifluoride solid or to aluminium oxide.

12. A process according to claim 3, wherein the step of removing low boiling point compounds includes heating the reaction products to a temperature below the sublimation point of aluminium trifluoride.

13. A process according to claim 12, wherein the removal step includes heating the reaction products to a temperature at which one or more of said low boiling point compounds are removed.

14. A process according to claim 6, wherein the feed material is a carbonaceous material containing the clay as an impurity.

15. A process according to claim 1, wherein the feed material is an aluminium ore having an aluminium content of at least 12 wt % alumina by ash analysis.

16. A process according to claim 15, wherein the feed material is a high alumina clay or leached high alumina clay.

17. A process according to claim 16 wherein the feed material is a leached high alumina clay.

18. A process according to claim 15 or 17, wherein the aluminium ore or leached high alumina clay is bauxite.

19. A process for obtaining one or more aluminium compounds from treatment of a bauxite feed material, including the steps of:
contacting said feed material with a fluorine acid solution to react with aluminium values and other reactive mineral species within the feed material to form gaseous silicon fluoride and aqueous soluble metal fluorides and/or metal fluosilicates;
separating the gaseous silicon fluoride from the reaction products and unreacted species of the feed material;
separating the aqueous reaction products from unreacted species of the feed material;
processing the aqueous reaction products to form a solid reaction product containing aluminium trifluoride and/or its hydrates; and
separating the aluminium trifluoride and/or hydrates from the solid reaction product.

20. A process according to claim 19, wherein, the step of separating the aluminium trifluoride includes the steps of:
converting any aluminium fluosilicate in said solid reaction product to aluminium trifluoride;
removing low boiling point compounds from said solid reaction product; and
heating said solid reaction product to a temperature to drive off gaseous aluminium trifluoride.

21. A process for obtaining one or more titanium compounds from treatment of a feed material containing an aluminium and titanium ore, including the steps of:
contacting said feed material with a fluorine acid solution to react said fluorine acid solution with aluminium and titanium values and other reactive mineral species within the aluminium ore to form gaseous silicon fluoride and aqueous soluble metal fluorides and/or metal fluosilicates as reaction products;
separating the gaseous silicon fluoride from the aqueous reaction products and unreacted species of the feed material;
separating the aqueous reaction products from unreacted species of the feed material;
processing the aqueous reaction products to form a solid reaction product containing titanium and aluminium metal fluorides, optionally titanium and aluminium metal fluosilicates and/or hydrates of said titanium and aluminium metal fluorides and/or metal fluosilicates; and
heating said solid reaction product to a temperature to drive off said titanium metal fluoride in gaseous form.

22. A process according to claim 21, wherein the major mineral components of said aluminium and titanium ore are aluminium and/or silicon minerals.
